(19) United States
(12) Patent Application Publication
(10) Pub. No.: US 2025/0034469 A1
(43) Pub. Date: Jan. 30, 2025

(54) ISOTOPOLOGUE MARKER FOR FLUID RESOURCES OR POLLUTANTS

(71) Applicants: ALBERT BLUE LLC, Dallas, TX (US); BOARD OF REGENTS, THE UNIVERSITY OF TEXAS SYSTEM, Austin, TX (US)

(72) Inventors: Albert HUDDLESTON, Dallas, TX (US); Fred MACDONNELL, Arlington, TX (US); Brian Harrison DENNIS, Arlington, TX (US)

(21) Appl. No.: 18/911,908

(22) Filed: Oct. 10, 2024

Related U.S. Application Data
(63) Continuation-in-part of application No. PCT/US2023/065643, filed on Apr. 11, 2023.
(60) Provisional application No. 63/362,867, filed on Apr. 12, 2022.

(51) Int. Cl. C10L 3/06; C10L 3/00

(52) U.S. Cl. CPC C10L 3/06; C10L 3/003; C10L 2230/16

(57) ABSTRACT

Systems and methods for chemically marking dry natural gas and other fluids are provided. In an example, at least 1 ppbv of a first isotopologue of a first hydrocarbon is added to the dry natural gas as a chemical marker. The first isotopologue has at least three deuterium atoms.

### RELATED APPLICATIONS

This application is a continuation-in-part application of International Application No. PCT/US2023/065643, filed Apr. 11, 2023, entitled “ISOTOPOLOGUE MARKER FOR FLUID RESOURCES OR POLLUTANTS”, which claims the benefit of U.S. Provisional Application No. 63/362,867, entitled “ISOTOPOLOGUE MARKER FOR FLUID”, the contents of which are incorporated herein by reference.

### BACKGROUND

Many different entities process fluids like natural gas, crude oil, water, and carbon dioxide. Often times, the shipment or storage of these fluids can result in fluids from different entities being combined. Once the fluids are combined it can be difficult or impossible to determine what entity provided the fluids and in what amount. For example, natural gas is often transported from a processor to a consumer via a network of pipelines. Many different entities may supply natural gas to the same network of pipelines and repositories. It is difficult to determine which entity's gas is present in a given pipeline or repository.

There is also a need for producers and processors of natural resources to employ environmentally responsible techniques and equipment in order to minimize the environmental impact of their operations. For example, there is a need for natural gas producers to minimize the emission of fossil fuels into the environment during the collection/production, processing, and/or transmission of natural gas. However, it is difficult to differentiate environmentally conscious players in the natural resource space from those that fail to employ appropriate resources and controls, especially when most such resources are indiscriminately combined at some point during transport to distributors and users.

### BRIEF DESCRIPTION

Some embodiments described herein provide for the addition of one or more chemical markers to a fluid along with the subsequent identification of the one or more chemical markers in the fluid. This process can be used to link information associated with the one or more chemical markers to the fluid. Any desired information can be associated with a marker and, in turn, the fluid that marker is in, such as, for example, the supplier of the fluid, whether the fluid meets a specific standard (e.g., some standard created to certify environmentally-sustainable practices), whether the fluid meets specifications for inclusion in a pipeline, whether the fluid was produced from a specific oil field/gas field or geographical region.

The chemical marker can be a unique molecule or a combination of two or more molecules at a unique ratio. As an example, the chemical marker can be one or more isotopologues of the primary fluid component of interest or a chemically similar compound. To illustrate, a chemical marker for methane (CH₄) or dry natural gas could be one or more isotopologues of methane, such CDH₂, CD₂H, CD₃H and/or CD₄ and/or one or more isotopologues of a related compound, such as the isotopologues of ethane (e.g., C₂DH₅, C₂D₂H₄, C₂D₃H₃, C₂D₄H₂, C₂D₅H, and/or C₂D₆) and/or propane (e.g., C₃DH₇, C₃D₂H₆, C₃D₃H₅, C₃D₄H₄, C₃D₅H₃, C₃D₆H₂, C₃D₇H, and/or C₃D₈). The chemical marker could be one of those molecules individually, or a combination of such molecules in a unique ratio.

One object of the invention is to identify fluids that may be mixed with other fluids of the same general nature. For example, dry natural gas (or some other fluid) supplied by a first producer may be mixed with dry natural gas (or the other fluid) supplied by a second producer. The subject fluids could be any other natural resource (e.g., crude oil, propane, etc.) or pollutant (e.g., carbon dioxide, carbon monoxide, sulfuric acid, etc.).

Another object of the invention is to provide apparatuses and methods for generating chemical markers.

Another object of the invention is to provide apparatuses and methods for detecting the presence and amount of a chemical marker(s) within a fluid.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of an example system for transporting a fluid;

FIG. 2 is an example chromatograph of a sample of chemically-pure (CP) grade methane showing that trace ethane can be separated by CP techniques;

FIG. 3 is another example chromatograph of the sample of FIG. 3 with a SIM selection for perdeuteroethane;

FIG. 4 is a calibration curve for perdeuteroethane in methane; and

FIG. 5 is a block diagram of an example system for synthesizing a marker for the fluid.

### DETAILED DESCRIPTION

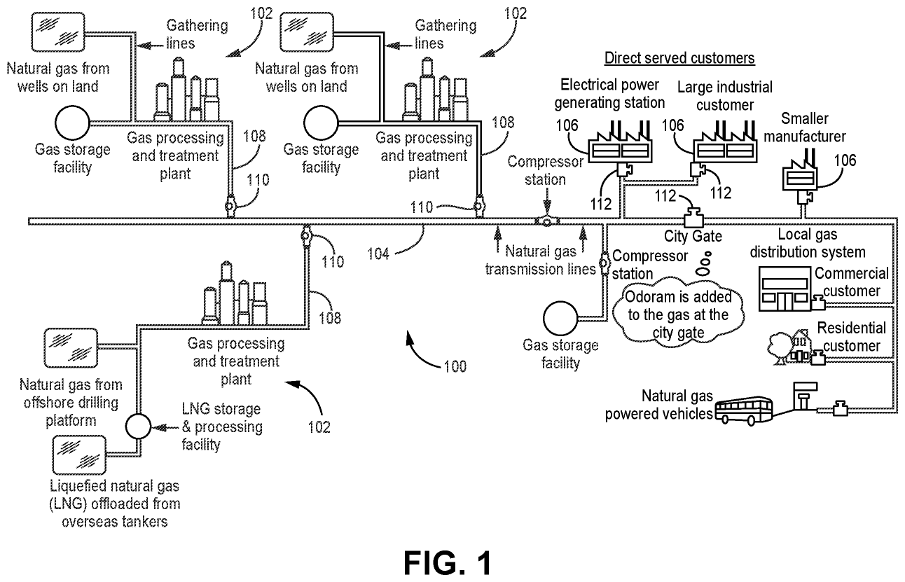

FIG. 1 is a block diagram of a system 100 for transporting a fluid. The system 100 can include a plurality of supply entities 102 which supply the fluid to a network 104 of pipes. The network 104 delivers the fluid to one or more destinations 106 for the fluid. The fluid can be any fluid which it is desirable to transport, including in a gas or liquid form, such as dry natural gas, wet natural gas, crude oil, water, carbon dioxide, ethane, or propane. Each supply entity 102 can be any appropriate entity involved in the supply or transport of the fluid to or within the network 104, such as a producer, processor, refiner, or distributor. The one or more destinations can be any appropriate entity that receives the fluid, such as a power plant, industrial plant, municipality, processing facility, refiner, transport swap location, or storage facility for the fluid. The network 104 of pipes can include one or more pipes of any appropriate size or design for transporting the fluid, including regional and interstate pipelines.

A respective supply line 108 transports the fluid from each supply entity 102 to the network 104 of pipes. Each supply line 108 transports fluid from a supply entity 102 to the network 104. In an example, only a single supply entity's 102 fluid is included in each supply line 108. The fluid from each supply entity 102 in each supply line 108 may be mixed with fluid from other supply entities 102 in the network 104 of pipes. That is, the network 104 of pipes can contain a mix of fluid (e.g., a mix of dry natural gas) derived from a plurality of supply entities 102.

In an example, each supply entity 102 can process the fluid prior to providing the fluid to the network 104 (e.g., prior to providing the fluid to the regional or interstate pipeline). This processing can be done to separate constituents of the fluid and/or to otherwise alter the fluid to be of appropriate quality for introduction to the network 104 (e.g., regional or interstate pipeline). In examples where the fluid is dry natural gas, the supply entity 102 can receive wet natural gas from, for example, one or more wells, storage facilities, and/or transport vehicles, and can process the wet natural gas to separate heavier hydrocarbons (e.g., ethane, propane, etc.) from the methane as well as remove non-hydrocarbon gasses if needed. The result of processing is a gas that is primarily methane and is known as dry natural gas (also referred to as pipeline quality natural gas). The dry natural gas is then provided to the network 104 for consumption by one or more destinations. Operators of regional and interstate pipelines often provide standards for the dry natural gas transported within their pipeline, and the supply entities 102 ensure their processing produces a dry natural gas that meets the standard of the pipeline transporting the gas.

Prior to the fluid from a supply entity 102 being introduced to the network 104 (i.e., before the fluid is mixed with the fluids provided by other entities 102) one or more chemical markers can be added to the fluid. The chemical marker(s) can be used as an indicator that can be detected in the fluid and used to indicate something about the fluid. The marker(s) can indicate anything that is desired and a list identifying each marker along with the information associated with that marker can be stored in any suitable form (e.g., in a written or electronic table) for marker detection as discussed below. Example information that a marker can indicate includes, but is not limited to, a source entity 102 for the fluid, a standard (e.g., pipeline standard or a standard associated environmentally-sustainable production processes) met by the fluid, or a quality of the fluid, whether the fluid meets specifications for inclusion in a pipeline, or whether the fluid was produced from a specific oil field/gas field or geographical region. As mentioned above, a marker can indicate that the fluid has a certain property or meets a certain standard. For example, a marker can be added to any fluid, regardless of source, if that fluid meets a first industry standard, such as a standard for responsible production and processing of natural gas. Such a marker can then be detected in a fluid to determine whether (and optionally, what percentage of) the fluid is fluid meeting the associated standard. Other information can also be associated with the markers.

Each marker can be unique among the markers added to the network 104, such that each marker can be independently detected in a fluid as discussed below. As an example of unique markers identifying unique source entities 102, a first unique marker can be added to fluid in the first supply line 108 from a first supply entity 102 and a second unique marker can be added to fluid in a second supply line 108 from a second supply entity 102. The first unique marker can be associated with the first supply entity 102 and the second unique marker with the second supply entity 102 such that fluid in the network 104 can be analyzed to detect whether the first and/or second markers are present and thus determine whether gas from the first and/or second entity 102 is present. The first and second unique markers can be comprised of different molecules or a different set of molecules or the same set of molecules at a different ratio. If the markers for the different supply entities are made using different ratios of the same set of molecules, detection would include assessment of the amounts of each of the different molecules along with a deconvolution calculation to resolve the amounts from each molecule present. Then, the markers that are present can be identified by determining which ratios and quantities of markers when combined would result in the amounts of each molecule that are present.

The chemical marker(s) can be added to the fluid, such that the marker(s) become a part of the fluid and remain a part of the fluid such that the marker(s) can be detected within the fluid at a later time. The chemical composition of the marker(s) can be selected such that the marker stays with the fluid while the fluid is stationary (e.g., during storage) and moves with the fluid while the fluid flows (e.g., during transport via pipeline).

A respective marker input station 110 can be disposed on respective supply lines 108 to add one or more markers to a fluid. The marker input stations 110 can have any suitable configuration, such as being part of a discharge station.

A centralized database or entity could be established for the purposes of establishing and assigning (associating) markers to a particular entity 102 (such as a specific supplier), to fluid(s) that meet a specific standard (e.g., some standard created to certify environmentally-sustainable practices), to fluid(s) derived from a specific oil field/gas field or geographical region, or the like. The centralized entity could also be a source of certified marker input stations 110 for the entities 102 to use to add their marker(s) to their fluid. The centralized entity could confine assignment of markers to entities 102 based on predetermined criteria such as demonstrated compliance with certain environmentally-conscious standards established by the centralized entity.

One or more marker detectors 112 can be disposed in one or more locations within the system 100 to detect markers in the fluid. For example, a gas storage facility fed by the network 104, or multiple supply lines 108, could be supplied with one or more marker detectors 112 to determine the presence and/or amount of markers in the received fluid(s) in order to determine the presence and/or amount of received fluids associated with the particular marker. As other examples, marker detector(s) 112 could be provided at a compressor station, a consumer location, or a city gate. As another example, an electric power generating station 106 can have a marker detector 112 that detects markers in the fluid it is receiving.

The detectors 112 can use any suitable method of detecting the marker(s) within a fluid. In an example, the detectors 112 use an appropriate analytical technique, such as a combination of gas chromatography and mass spectrometry (GC-MS) to detect and optionally quantify markers in the fluid. Mass spectrometry can be use to quantitate the marker in low concentrations. Gas chromatography can be used to separate the marker, to the degree possible, from the other components so as to improve the sensitivity of the MS detector to the marker. In another example, Cavity Ring Down Spectrophotometers (CRDS) can be used. The CRDS can be optimized to identify a specific analyte in a specific matrix. This could be used for relatively simple matrixes (i.e., natural gas).

As mentioned, the chemical markers can be associated with information and identification of a chemical marker in the fluid can be used to link that information with the fluid. Once one or more markers are identified in the fluid, the information associated with those markers can be linked to the fluid to, for example, identify which entity (ies) 102 are supplying the fluid and/or what criteria (e.g., standards) is met by the fluid. In an example, the detectors 112 can occasionally (e.g., periodically) continually analyze the fluid to provide data on the content of the fluid. In an alternative example, the detectors 112 can continually analyze the fluid to provide continual data on the content of the fluid.

The system 100 shown in FIG. 1 is one example of a system for the marking of a fluid, such as natural gas, that is mixed with other fluids in a repository such as a network 104 of pipes. In other examples, the fluids can be supplied or mixed in repositories during storage (e.g., in a man-made or natural structure container) or during transport (e.g., in a container that can be placed on a truck, train, ship, and the like). In such other systems, a marker can be input into the fluid prior to the fluid being mixed with other fluids. In some examples, markers can be input into a fluid that is already a mixture from multiple entities, including prior to that mixture being mixed with still other fluids. Such a marker could be added to identify a regional mix of the fluid and can be used in addition to markers identifying individual supply entities 102. As long as each marker is uniquely detectable, the markers can be added to a fluid at any point during that fluid's life for any desired reason.

The chemical composition of the marker(s) as well as the particular amount of marker added to the fluid can be selected such that the marker is detectable as an artificially present quantity of the particular chemical composition. That is, in order to be definitively identifiable as a marker, the chemical composition of the marker is present in the fluid in an amount that is above a regular (e.g., naturally-occurring) quantity of the chemical. The specific amount of marker that is needed in order to be above a regular quantity of the chemical depends on the chemical composition of the marker and the chemical composition possible/expected in the fluid. In an example, isotopologues of molecules are used as molecules for the markers because isotopologues are naturally present in smaller amounts in most fluids. Because they are present in smaller amounts, smaller amounts of the molecules are needed in order to overcome the regular (e.g., naturally-occurring) quantities. In a particular example, the isotopologues are deuterated versions of a molecule in which deuterium atoms are in place of hydrogen atoms in the molecule.

In an example, the chemical composition of each marker can be selected such that the marker can be detected by the detectors 112 and uniquely distinguished from other chemical markers. For example, if the detectors use chromatography to identify some or all of the markers, the chemical composition of each marker can be selected such that each marker provides a unique chromatography signature. In an example, a unique chromatography signature can be achieved by selecting molecules with different retention times, e.g., at least ten seconds apart. In some examples, multiple different technologies can be used to detect the molecule(s) of the markers such that a given marker need not be uniquely identifiable via a single technology if it is uniquely identifiable via the combination of technologies used.

In an example, the chemical composition of a marker can be selected and that marker can be added using a method that enables a quantity and/or percentage of a fluid corresponding to the marker to be determined after that fluid has been mixed with other fluids that do not have the same marker. For example, it may be desirable to know not only whether a particular entity's 102 fluid is present in a composition, but additionally how much of that entity's 102 fluid is present in a composition. To accomplish this a chemical marker can be selected that is both uniquely identifiable via the detectors 112 and the detectors 112 can also determine a quantity of the marker that is present. The quantity can be an absolute quantity or a relative quantity, such that the quantity of marker relative to other markers is determined. In such an example, the process of adding the marker to the corresponding fluid (e.g., to the fluid of the first entity 102 prior to mixing) can be metered such that the amount of marker added corresponds to the amount of the corresponding fluid present. The amount of marker added can be kept at constant ratio with respect to the amount of fluid present. For example, a first marker corresponding to the first entity 102 can be added such that the first marker 102 is present in the first entity's fluid at an amount of 1 part per million by volume (ppmv). The detectors 112 can then determine the quantity of fluid from the first entity 102 in a composition based on the quantity of the first marker detected. That is, if the first marker is detected at a quantity of 1 ppmv, 100% of the composition is the first entity's fluid. If the first marker is detected at a quantity of 0.5 ppmv, 50% of the composition is the first entity's fluid. While this example uses a concentration of 1 ppmv, any appropriate amount can be used. To enable the quantity of marker to correspond to the quantity of its corresponding fluid, the chemical composition of the marker can be selected such that it dilutes in a composition in a deterministic manner (e.g., at the same rate as or proportion to its corresponding fluid). For example, if 50% of a composition is composed of a fluid originating from a first entity 102 having a first marker, the first marker is selected such that it will be present in that composition at a quantity that is 50% of the level at which it was added. Other methods of adding and detecting can also be used.

As discussed above, the chemical marker can comprise a combination of two of more molecules (e.g., isotopologues) in a defined ratio. For example, a 1:1 molar (or volume) mixture of C₂D₆ and C₂H₃D₃ could be added at concentration of 1000 ppbv (500 ppbv each) to the dry natural gas. Other ratios of C₂D₆ and C₂H₃D₃, such as 1:5, 1:3, 1:2, 2:3, 3:2, 3:1, or 5:1, etc., can also be used. By using a chemical marker that is a defined ratio of multiple isotopologues, a unique fingerprint can be formed. In an example, multiple such defined ratio mixtures of two or more isotopologues can be used as markers, wherein the ratio mixtures are selected such that they can then be deconvoluted even when multiple such markers are present in a single fluid. Moreover, using defined ratios of multiple isotopologues can provide a ratiometric method for detecting a quantity of the marker and its corresponding fluid that are present.

To determine which markers are present in a fluid, and optionally a quantity of the marker that is present, the detectors 112 can perform mass spectrometry on the fluid and determine which molecules being used as markers are present in the fluid. A set of information corresponding to the molecular weights of each molecule being used as a marker can be provided. For example, if the molecules used for the markers consist of C₂D₆ and C₂D₄H₂, the set of information includes about 36 for C₂D₆ and about 34 for C₂D₄H₂. The detector 112 analyzes the output of the mass spectrometry to determine if molecules with a molecular weight of about 36 and about 34 were detected. In an example, a molecule having a molecular weight in the set is detected if the area under the curve can be reliably integrated for that molecular weight. The detector 112 can then determine which markers are present based on which molecules were detected. If, for example, each marker is a single molecule, then detection of a molecule having a molecular weight corresponding to the set of marker molecules is detection of a marker. If, in other examples, each marker is a defined ratio of multiple molecules, the detector 112 can deconvolute the results to determine which markers are present. Such deconvolution can use a linear programming algorithm that takes as inputs the quantity of each relevant molecule detected in the fluid with the mass spectrometry along with the information on each marker, the molecules that make up the marker and the ratio for those molecules. The linear programming algorithm then calculates and outputs the set of one or more markers (e.g., the set of one or more ratios of molecules corresponding to each marker), and optionally the amounts, that make up the quantity of molecules detected. This output identifies the markers that are present in the fluid. A calibration curve can be provided for each molecule used as a marker that indicates the correspondence between the area under the detection curve (obtained via integration) from mass spectrometry for a particular molecular weight to the quantity of that molecule that is present. The detector 112 can compare the area obtained for a molecular weight to the calibration curve for that molecular weight to determine the quantity of molecule that is present.

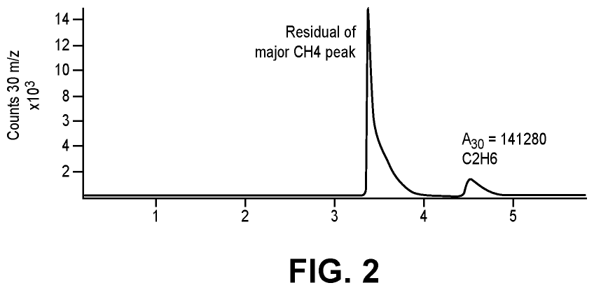

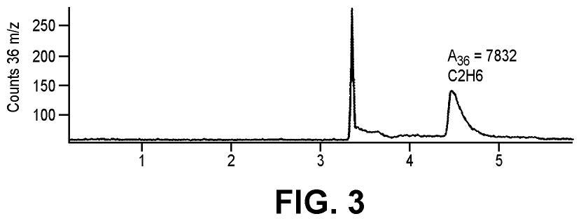

FIG. 2 is an example chromatograph for a sample containing ethane (C₂H₆) and perdeuteroethane (C₂D₆) in methane using this set-up of the PLOT column and a 300 μL injection volume. As shown, the CH₄ peak elutes at about 3.4 min whereas the C₂H₆ peak has a retention time of about 4.6 min. The concentration of ethane in the tested sample was 10.3 ppmv in chemically pure methane and this can be determined from the area of the SIM m/z 30 (C₂H₆⁺) peak (A30=141280) once compared to the calibration curve. Also contained in this sample is 573 ppbv C₂D₆ which also has a retention time of 4.6 min. FIG. 3 is a chromatograph showing a profile from the sample when the SIM detected is set to m/z=36 (C₂D₆⁺). As shown, the much smaller C₂D₆ peak can be seen and the area quantified despite co-eluting with much larger ethane peak. The C₂D₆ concentration is consistent with the value obtained when the area of the A36 peak is compared with the calibration curve. Due to variations in instrument performance, the instruments are individually calibrated and a specific calibration curve is developed for each analyte.

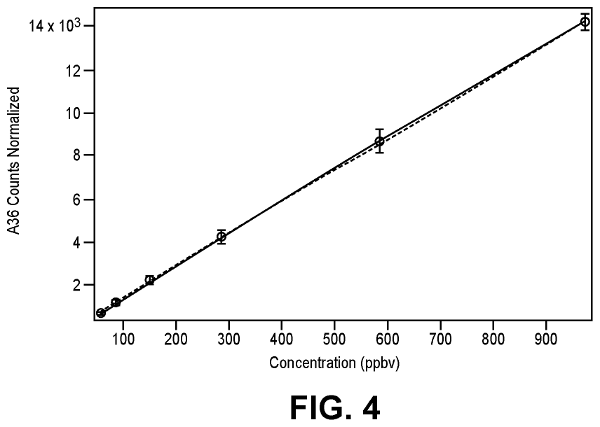

FIG. 4 is an example calibration curve for various concentrations of C₂D₆ in chemically pure methane in the range of 50 to 1000 ppbv. Open circles and error bars show the average and standard deviation of three measurements at each concentration. A linear fit to the data with a correlation coefficient of 0.9997 is also shown. MSD in SIM mode with m/z=36 was used. The table below shows the measurements included in the calibration curve.

| C₂D₆ ppbv | Area36 Avg | Std Dev |
|---|---|---|
| 57 | 678 | 87 |
| 86 | 1204 | 68 |
| 150 | 2206 | 164 |
| 286 | 4217 | 333 |
| 586 | 8661 | 559 |
| 976 | 14175 | 380 |

This calibration curve provided an excellent linear fit to the data, good reproducibility in any given measurement and quantitative detection down to 50 ppbv (LOQ). The curve has a slope of 14.6±0.13 and a y-intercept of −37.2±61.2. The quantitative expression for this fit is: A36/14.6=[C₂D₆] in ppbv. The limit of detection is about half this value, about 25 ppbv. It is contemplated to use larger injection volumes (>300 μL) and a split-less injection, however, the most stable performance was found at a split of 0.5:1. A split is when the analyte gas is mixed with the carrier gas in a mixing chamber prior to the introduction to the column. No split would mean that no such premixing was done. Without a split, the local pressure can be off and the resulting separation is poor. In this example 150 μL of Helium was mixed with the 300 μl sample for a 0.5:1 split.

In an example, the chemical composition of a marker can be selected such that the marker does not significantly alter the chemical properties of the fluid. This can be accomplished by selecting a marker that has similar chemical properties to a molecule that is already present in the fluid. In this way, the marker can be added without having a meaningful impact on the properties of the fluid, e.g., without impacting the energy efficiency of the fluid. In one example, the molecule(s) of a marker is an isotopologue of a molecule or type of molecule typically present in the fluid. The molecule (e.g., ethane) or type of molecule (e.g., hydrocarbon) of which the marker is an isotopologue is ideally present at a relatively low concentration or altogether absent from the fluid absent the deliberate introduction of the molecule. For example, it is preferable that the molecule(s) that make up a marker are generally naturally present in the fluid at a concentration of less than about 1000 ppmv, more preferably less than about 100 ppmv, and most preferably less than about 10 ppmv, or 1 ppmv. In examples where the fluid is a gas, concentration is measured as a volumetric percentage of the fluid (e.g., 10 ppmv). In examples where the fluid is a liquid, the concentration can be measured as the percent mass of the fluid. As an example, each molecule of a marker is added at a concentration of greater than about 0.1 ppbv, such as between 0.1 ppbv to 1000 ppmv. For example, the molecule(s) can be added at a concentration greater than about 0.1 ppbv, 0.25 ppbv, 0.5 ppbv, 1 pbbv, 2.5 ppbv, 5 ppbv, 10 ppbv, 25 ppbv, 50 ppbv, 100 ppbv, 250 ppbv, 500 ppbv, 1 ppmv, 2.5 ppmv, 5 ppmv, 10 ppmv, 25 ppmv, 50 ppmv, 100 ppmv, 250 ppmv, 500 ppmv, or 1000 ppmv. For liquids being marked, the units used herein (including in the above concentrations) would be in mass fraction parts-per notation (e.g., ppb, ppm) instead of parts-per volume notation (e.g., ppbv, ppmv). This, for example, means that the concentrations above for a liquid would be greater than about 0.1 ppb, such as between 0.1 ppb and 1000 ppm.

In an example, the chemical composition of a marker can be selected such that it does not violate the composition requirements for the fluid. For example, there are industry specifications for the composition of dry natural gas and the marker, in such cases, is selected such that it is an acceptable additive.

In an example, the fluid is natural gas and the molecule(s) of a marker are an isotopologue of a hydrocarbon, such as an alkane or alkene. Some exemplary alkanes and alkenes are those having one to three carbon atoms (e.g., perdeuteroethane, perdeuteroethlyene, perdeuteropropane, perdeuteropropene). Example molecules of which the isotopologue can be formed include methane, ethane, propane, butane, ethylene, propylene, pentane, or butene. Natural gas is composed primarily of hydrocarbons, so having the marker be an isotopologue of a hydrocarbon means that the marker will not significantly change the chemical properties of the gas. Alternatively, it could be a different molecule naturally occurring in natural gas, such as carbon dioxide, nitrogen, hydrogen sulfide, or helium. Natural gas can contain low concentrations of isotopologues of alkanes. In such cases, the amount of the particular isotopologue(s) used are selected to be higher than the natural abundance level of that isotopologue as discussed below.

In an example, the molecule(s) of a marker are deuterium-based isotopologues of a hydrocarbon. This can include, for example, deuterium-based isotopologues of methane, including one or more of CD₄, CD₃H, CD₂H₂, CDH₃ and/or deuterium-based isotopologues of ethane, such as C₂D₆, C₂H₂D₄, C₂H₃D₃, etc. Such an isotopologue has one or more of the hydrogens (¹H, protium, or simply H) substituted with deuterium (²H or D). In other examples, the isotopologue can be a carbon-based isotopologue (e.g., can include a 13-carbon isotope). Such carbon-based isotopologues can, but need not, include a deuterium isotope as well. A preferred chemical marker for use with methane is C₂H₆. A preferred chemical marker for carbon dioxide is CD₄.

It is possible that a selected molecule to be used as an isotopologue marker alone or in combination with other molecules will be naturally present in the fluid in small amounts. In this circumstance, the isotopologue can be used at a concentration that is sufficiently above the naturally-occurring amount, such that the artificially high level of the isotopologue can identified as a marker (or a component of a marker if multiple molecules are used for a single marker). It can be advantageous to use isotopologues having more isotopes (e.g., more deuterium atoms) as molecules in the markers, because the more isotopes in an isotopologue, the lower the natural abundance of the isotopologue. Hydrocarbon isotopologues with low numbers of deuterium atoms (e.g., one deuterium atom) may be naturally present in small amounts in the fluid. However, the more deuterium atoms present in an isotopologue, the lower amount of that isotopologue that is naturally present in the fluid. For example, C₂D₂H₄ is naturally present in natural gas at a rate of around 24 ppbv or less, C₂D₃H₃ is naturally present in natural gas at a rate of around 3.17e⁻¹². In an example, the molecule(s) in the markers have at least three deuterium atoms in order to ensure that the molecule(s) are naturally present in sufficiently low amounts in the fluid. In another example, the molecule(s) in the markers have at least four deuterium atoms in order to further ensure that the molecule(s) are naturally present in sufficiently low amounts in the fluid. For hydrocarbons having more than three carbon atoms (e.g., butane), at least six deuterium atoms can be included in the isotopologue molecules used as markers. In another example, at least half of the hydrogen atoms in the molecules of the marker are substituted with deuterium atoms. That is, the molecule(s) in the markers have at least N/2 deuterium atoms where N is equal to the number of hydrogen atoms in the corresponding molecule. For ethane, this would mean that the molecule(s) of the markers would have at least three deuterium atoms (i.e., including C₂D₃H₃, C₂D₄H₂, C₂D₅H, and C₂H₆), because ethane has six hydrogen atoms. The below table lists the natural abundance of deuterium-based isotopologues of methane in natural gas.

| | Naturally- | | | |
|---|---|---|---|---|
| Methane | occurring | | Exemplary Marker | |
| Isotopologue | Range | Unit (by volume) | Concentrations | |
| CD₄ | >0.03 | Part per trillion (ppt) | 1-500 | ppmv |
| CD₃H | 108 to 1 | Part per trillion | 1-500 | ppmv |
| CD₂H₂ | 360 to 22 | Part per billion (ppb) | 1-500 | ppmv |
| CDH₃ | 1200 to 75 | Part per million (ppm) | 1000-5000 | ppmv |

To detect isotopologues of ethane, a combination gas chromatographer and mass spectrophotometer, such as by using a Shimadzu TQ8030, can be optimized for methane and ethane separation. Mass spectrometry detection of trace amounts of the isotopologue in the natural gas is very sensitive and, as such, can provide definitive identification and quantification of the isotopologue. For example, separation of trace ethane, propane, and butane (including their isotopologues) from methane can be accomplished with a 50 meter Al₂O₃/KCl porous layer open tubular (PLOT) column and selective ion mode (SIM) can be used. An oven temperature of between 100° C. and 0° C. can be used with improved separation at the lower temperatures (e.g., 10-50° C., preferably 20-40° C., more preferably 25-35° C., most preferably 30° C.). Different detection parameters and equipment may be used for different fluids or marker molecules.

Any other combinations of isotopologues of ethane could also be used at a unique ratio. Additionally, an isotopologue of one hydrocarbon could be used at a unique ratio with an isotopologues of another hydrocarbon, for example, an isotopologue of ethane could be used with C₃D₉. The table below provides other exemplary markers along with relevant physical data.

| Name | Formula | m/z | bp (K) |
|---|---|---|---|
| methane | CH₄ | 16 | 91 |
| methane-d4 | CD₄ | 20 | ~91 |
| ethane | C₂H₆ | 30 | ~184 |
| ethane-d6 | C₂D₆ | 35 | ~184 |
| ethane-d5 | C₂D₅H | 36 | ~184 |
| ethylene-d4 | C₂D₄ | 28 | 169 |
| propane-d8 | C₃D₈ | 52 | ~231 |

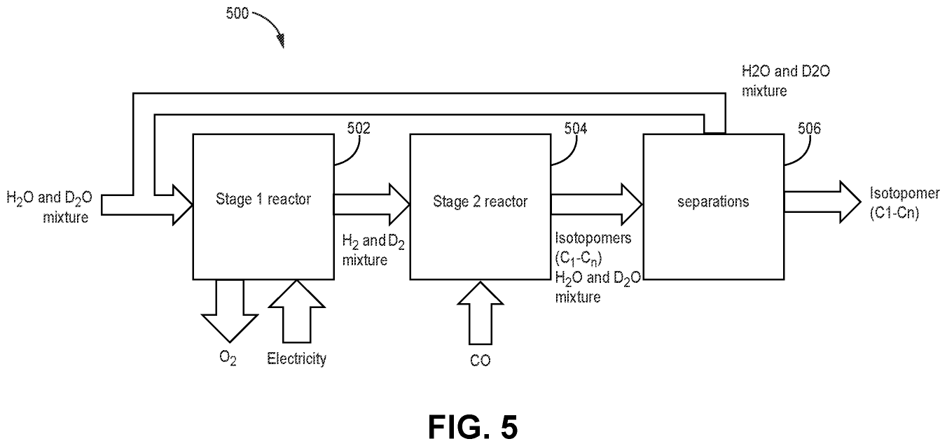

FIG. 5 is a block diagram of an example method 200 for producing isotopologues of alkanes (e.g., C₂D₆) that can be used as a marker for natural gas. The method 500 of FIG. 5 can economically generate isotopologues of alkanes using a two-stage reaction based on regular water (H₂O), heavy water (D₂O), and carbon monoxide (CO). The two stages 502, 504 of the method operate in series with output from the first stage 502 being passed to the second stage 504. The first stage 502 of the method 500 includes applying electricity to perform electrolysis on the heavy water and optionally also regular water to split the deuterium and hydrogen if present from the oxygen. The regular water and heavy water can be pumped from a storage tank to have a continuous input of heavy water and regular water.

The oxygen output from this first stage 502 can be exhausted to the atmosphere or contained for some other use. The di-deuterium and optionally di-hydrogen from the first stage 202 is passed to the second stage 204 of the process 200. Carbon monoxide is input to the second stage 204, which uses a catalyst, such as platinum, and a heater to reduce isotopologues of alkanes from the CO and di-deuterium/hydrogen inputs. Stage 2 of the reaction generates a mixture of isotopologues of alkane, heavy water, and optionally regular water.

The mixture of isotopologues, heavy water, and regular water can be separated 506 using a series of condensers operating at low, such as cryogenic, temperatures. The heavy water and regular water can be collected and recycled back to the input of the first stage 202. The isotopologues included in the output of the second stage 504 can be controlled by adjusting the ratio of heavy water to regular water input into the first stage 502 along with the temperature and pressure used in the second stage 504. For example, if no regular water is input (i.e., only heavy water is input) into the first stage 502 only fully deuterated alkanes (e.g., CD₄ and C₂D₆) will be output from the second stage 504. The ratio of regular water input into the first stage 502 dictates the ratio of deuterated alkanes output in the second stage 504.

In a particular example, 99% pure heavy water can be input to the first stage 502 at a rate of 305 mL per day. The separated oxygen is a byproduct and is output from the first stage 502, for example, at a rate of 15.7 cubic feet per day. In an example, the carbon monoxide can be fed from gas cylinders and input into the second stage 504 at a continuous rate of about 8.7 cubic feet per day. In this example, C₂D₆ is output from the separator at a rate of about 5 cubic feet per day. Production of C₂D₆ at 5 cubic feet per day could mark 100 million cubic feet of dry natural gas at a concentration of 50 ppbv. The two-stage process can operate at low pressure (e.g., 20 psig or less) to efficiently create the C₂D₆.

In an example, other isotopologues of ethane can be made using the same two-stage reaction as in method 200 except the heavy water input to the first stage is replaced with a mix of heavy water and regular water (H₂O). The mix of heavy water and regular water will result in a mixture of methane, ethane and their isotopologues being generated by the two-stage reaction including, for example, C₂D₆ and C₂H₂D₄. The ratio of heavy water to regular water can be varied to vary the statistical mixture of isotopologues in the output. The ratios of heavy water and regular water can be selected such that the output from a given reaction results in a uniquely identifiable mixture of isotopologues that can be used, or modified to be used, as a marker. The different ethane isotopologues can be separated and used as individual markers or combined with one another in uniquely identifiable ratios as described above. In any case, the markers created can be compressed into cylinders for transport to the appropriate marker input station 110.

A similar approach can be used for markers for other fluids such as carbon dioxide (CO₂), crude oil, and water. In an example, an isotopologue of methane (e.g., CD₄) can be used as a chemical marker for carbon dioxide. Other example molecules for use alone or in combination as markers for carbon dioxide include those in the table below.

| Name | Formula | m/z | bp (K) |
|---|---|---|---|
| perdeuteromethane | CD₄ | 16 | 91 |
| fluoromethane | CH₃F | 34 | 195 |
| perdeuterofluoromethane | CD₃F | 37 | ~195 |
| difluromethane | CH₂F₂ | 52 | 221 |
| ethane | C₂H₆ | 30 | ~184 |
| ethane-d6 | C₂D₆ | 35 | ~184 |
| ethane-d5 | C₂D₅H | 36 | ~184 |
| ethylene-d4 | C₂D₄ | 28 | 169 |
| ethane-d2 | C₂D₂H₄ | 32 | ~184 |
| fluoroethanes | C₂HxF₆-x | varies | varies |
| perdeuterofluoroethanes | C₂DxF₆-x | varies | varies |
| propane | C₃H₈ | 44 | 231 |
| propane-d8 | C₃D₈ | 52 | ~231 |
| propane (d7-d2) | | | |
| butane (d10-d2) | | | |

In examples where the fluid being marked is crude oil, exemplary molecules to be used in markers include hydrocarbons in the C8-14 range (eight to fourteen carbon atoms), including both straight chain or branched hydrocarbons and/or molecules that include fluorine or chlorine. Isotopically labelled paraffins and alcohols could be used as labels for water or for crude oil. In another example, isotopologues of one or more aromatic compounds are used as markers for crude oil. The proposed reaction process described above for deuterated ethane can also be adapted to synthesize longer chained isotopically labelled paraffins and alcohols for labeling liquid products, such as crude oil and water.

The two-stage reaction for any of the above methods can use a temperature and pressure controlled stainless-steel tube reactor packed with a catalyst. The two stages can be performed at the same or different pressures, for example, at a pressure in the range of 1 to 50 bar, more preferably 1 to 20 bar, or most preferably in the range of 1 to 5 bar. In an example, the first stage is performed at a pressure of less than about 3 bars and the second stage is performed at a pressure of greater than about 3 bars. In an example, the second stage is maintained at a temperature of between about 100 and about 1200 degrees Celsius, for example between about 200 and about 400 degrees Celsius. The temperature can be controlled via an electric heater and a control system that monitors the temperature at multiple locations. The reactor length and diameter is sized for the design flow rates along with the amount of catalyst.

The marker produced by any of the methods described herein can be compressed and then subsequently injected into the desired fluid or stored in cylinders for transport or later use.

What is claimed is:

1. Natural gas comprising at least 1 ppbv of a first isotopologue of a first hydrocarbon, the first isotopologue having at least three deuterium atoms.

2. The natural gas of claim 1, wherein the first hydrocarbon is an alkane.

3. The natural gas of claim 2, wherein the alkane is ethane.

4. The natural gas of claim 3, wherein the first isotopologue is C₂D₆.

5. The natural gas of claim 1, comprising at least 1 ppbv of a second isotopologue of a second hydrocarbon other than methane, the second isotopologue having at least three deuterium atoms and being different than the first isotopologue.

6. The natural gas of claim 5, wherein the first hydrocarbon is a first alkane and the second hydrocarbon is a second alkane.

7. The natural gas of claim 6, wherein the first alkane is ethane and the second alkane is one of ethane or propane.

8. The natural gas of claim 7, wherein the second isotopologue is one of C₂H₂D₄ or C₃D₈.

9. The natural gas of claim 7, wherein the second isotopologue is perdeuteropropane (C₃Dg).

10. The natural gas of claim 1, wherein the natural gas is wet natural gas.

11. The natural gas of claim 1, wherein the natural gas is dry natural gas.

12. A method comprising adding at least 1 ppbv of a first isotopologue of a first hydrocarbon other than methane to natural gas, the first isotopologue having at least three deuterium atoms.

13. The method of claim 12, wherein the first hydrocarbon is an alkane.

14. The method of claim 13, wherein the alkane is ethane.

15. The method of claim 14, wherein the first isotopologue is C₂D₆.

16. The method of claim 12, comprising adding at least 1 ppbv of a second isotopologue of a second hydrocarbon other than methane to the natural gas, the second isotopologue having at least three deuterium atoms and being different than the first isotopologue.

17. The method of claim 16, wherein the first hydrocarbon is a first alkane and the second hydrocarbon is a second alkane.

18. The method of claim 17, wherein the first alkane is ethane the second alkane is one of ethane or propane.

19. The method of claim 18, wherein the second isotopologue is one of C₂H₂D₄ or C₃D₈.

20. The method of claim 18, wherein the second isotopologue is perdeuteropropane (C₃D₉).

21. The method of claim 12, wherein the natural gas is wet natural gas.

22. The method of claim 12, comprising:
receiving wet natural gas;
processing the wet natural gas to produce dry natural gas; and
providing the dry natural gas to a first repository, the first repository comprising a pipeline that transports dry natural gas from multiple processing plants or a container that receives dry natural gas from multiple processing plants, wherein adding at least 1 ppbv of a first isotopologue includes adding the at least 1 ppbv prior to providing the dry natural gas to the first repository.

23. The method of claim 12, comprising:
analyzing natural gas with a combination of gas chromatography and mass spectrometry; and
determining based on the analyzing whether the analyzed natural gas has had at least 1 ppbv of a first isotopologue of a first hydrocarbon other than methane added to it, the first isotopologue having at least three deuterium atoms.

24. The method of claim 23, wherein determining includes deconvoluting results from analyzing to identify multiple unique chemical markers having defined ratios of at least two different molecules.
